(19) United States
(12) Patent Application Publication
(10) Pub. No.: US 2005/0020467 A1
(43) Pub. Date: Jan. 27, 2005

(54) Gelled light duty liquid cleaning composition

(75) Inventor: Kevin Kinscherf, Freehold, NJ (US)

Correspondence Address: Patent Department;Colgate-Palmolive Company, 909 River Road, P.O. Box 1343, Piscataway, NJ, 08855-1343, US

(73) Assignee: Colgate-Palmolive Company

(21) Appl. No.: 10/925,549

(22) Filed: Aug. 25, 2004

Related U.S. Application Data
(63) Continuation-in-part of application No. 10/624,273, filed on Jul. 22, 2003, now abandoned.

(51) Int. Cl. C11D 1/00

(52) U.S. Cl. 510/403

(57) ABSTRACT

A gelled light duty cleaning composition comprising: a C₈-C₁₈ ethoxylated alkyl ether sulfate surfactant, a magnesium salt of a C₈-C₁₈ linear alkyl benzene sulfonate, a sodium salt of a C₈-C₁₈ linear alkyl benzene sulfonate, an amine oxide surfactant, a polyalkylglucoside, a hydrophobic ethoxylated nonionic surfactant and water.

This application is a continuation-in-part of prior co-pending application U.S. Ser. No. 10/624,273 filed Jul. 22, 2003, the disclosure of which is incorporated herein by reference.

### FIELD OF THE INVENTION

The present invention relates to novel light duty liquid detergent compositions that display excellent suspension properties, no phase separation and have good foaming and grease cleaning properties.

### BACKGROUND OF THE INVENTION

The prior art is replete with light duty liquid detergent compositions containing nonionic surfactants in combination with anionic and/or betaine surfactants wherein the nonionic detergent is not the major active surfactant. In U.S. Pat. No. 3,658,985 an anionic based shampoo contains aminor amount of a fatty acid alkanolamide. U.S. Pat. No. 3,769,398 discloses a betaine-based shampoo containing minor amounts of nonionic surfactants. This patent states that the low foaming properties of nonionic detergents renders its use in shampoo compositions non-preferred. U.S. Pat. No. 4,329,335 also discloses a shampoo containing a betaine surfactant as the major ingredient and minor amounts of a nonionic surfactant and of a fatty acid mono- or di-ethanolamide. U.S. Pat. No. 4,259,204 discloses a shampoo comprising 0.8 to 20% by weight of an anionic phosphoric acid ester and one additional surfactant which may be either anionic, amphoteric, or nonionic. U.S. Pat. No. 4,329,334 discloses an anionic-amphoteric based shampoo containing a major amount of anionic surfactant and lesser amounts of a betaine and nonionic surfactants.

U.S. Pat. No. 3,935,129 discloses a liquid cleaning composition containing an alkali metal silicate, urea, glycerin, triethanolamine, an anionic detergent and a nonionic detergent. The silicate content determines the amount of anionic and/or nonionic detergent in the liquid cleaning composition. However, the foaming properties of these detergent compositions are not discussed therein.

U.S. Pat. No. 4,129,515 discloses a heavy duty liquid detergent for laundering fabrics comprising a mixture of substantially equal amounts of anionic and nonionic surfactants, alkanolamines and magnesium salts, and, optionally, zwitterionic surfactants as suds modifiers.

U.S. Pat. No. 4,224,195 discloses an aqueous detergent composition for laundering socks or stockings comprising a specific group of nonionic detergents, namely, an ethylene oxide of a secondary alcohol, a specific group of anionic detergents, namely, a sulfuric ester salt of an ethylene oxide adduct of a secondary alcohol, and an amphoteric surfactant which may be a betaine, wherein either the anionic or nonionic surfactant may be the major ingredient.

The prior art also discloses detergent compositions containing all nonionic surfactants as shown in U.S. Pat. Nos. 4,154,706 and 4,329,336 wherein the shampoo compositions contain a plurality of particular nonionic surfactants in order to affect desirable foaming and detersive properties despite the fact that nonionic surfactants are usually deficient in such properties.

U.S. Pat. No. 4,013,787 discloses a piperazine based polymer in conditioning and shampoo compositions which may contain all nonionic surfactant or all anionic surfactant.

U.S. Pat. No. 4,450,091 discloses high viscosity shampoo compositions containing a blend of an amphoteric betaine surfactant, a polyoxybutylenepolyoxyethylene nonionic detergent, an anionic surfactant, a fatty acid alkanolamide and a polyoxyalkylene glycol fatty ester. But, none of the exemplified compositions contain an active ingredient mixture wherein the nonionic detergent is present in major proportion which is probably due to the low foaming properties of the polyoxybutylene polyoxyethylene nonionic detergent.

U.S. Pat. No. 4,595,526 describes a composition comprising a nonionic surfactant, a betaine surfactant, an anionic surfactant and a C₁₂-C₁₄ fatty acid monoethanolamide foam stabilizer.

U.S. Pat. No. 5,998,347 describes a similar composition to the instant invention which uses a C₁₀ alkyl amido propyl dimethyl amine oxide.

### SUMMARY OF THE INVENTION

It has now been found that a light duty liquid detergent having excellent suspension properties, no phase separation and having good foaming and grease cleaning properties can be formulated with a magnesium salt of a C₈-C₁₈ linear alkyl benzene sulfonate, an alkyl polyglucoside, a C₈-C₁₈ ethoxylated alkyl ether sulfate, a hydrophobic ethoxylated nonionic surfactant and water with optional ingredients such as a preservative and perfume.

To achieve suspension of materials like gelatin beads in a liquid, a gel is formed by the above composition. Without gel formation, beads will not be uniformly distributed in the liquid. A gel is defined for this purpose as a non-newtonian liquid that displays apparent yield behavior when subjected to shear stress. Typically, light duty liquids do not display an apparent yield stress.

### DETAILED DESCRIPTION OF THE INVENTION

The present invention relates to a gelled light duty liquid detergent which comprises approximately by weight:
(a) 2% to 9% of a magnesium salt of a C₈-C₁₈ linear alkyl sulfonate surfactant;
(b) 0% to 4% of a sodium salt of a C₈-C₁₈ linear alkyl sulfonate surfactant;
(c) 0% to 6% of an amine oxide surfactant;
(d) 3% to 8% of an alkyl polyglucoside surfactant;
(e) 0 to 2 wt. %, more preferably 0.05% to 2.5% of a perfume;
(f) 10% to 20% of a C₈-C₁₈ ethoxylated alkyl ether sulfate;
(g) 0 to 1%, more preferably 0.01% to 0.5% of a preservative;
(h) 0 to 0.5 wt. %, more preferably 0.05% to 0.4% of a chelating agent;
(i) 0.25% to 3% of a C₁-C₃ alkanol;
(j) 0.3% to 2% by weight of a solubilizing agent which is a water soluble salts of C₁-C₃ alkyl substituted benzene sulfonate hydrotropes and mixtures thereof
(K) 10% to 20% of a hydrophobic nonionic surfactant having an HLB of about 3 to about 10; and
(l) the balance being water. The composition is pourable and is a gel having an apparent yield value of greater than 5 Pa, thereby permitting the suspension of beads in the gelled composition.

The C₈-C₁₈ ethoxylated alkyl sulfate surfactants have the structure
R—(OCHCH₂)ₙOSO₃⁻M⁺
wherein n is about 1 to about 22 more preferably 1 to 3 and R is an alkyl group having about 8 to about 18 carbon atoms, more preferably 12 to 15 and natural cuts, for example, C₁₂₋₁₄; C₁₂₋₁₅ and M is an ammonium cation, alkali metal or an alkaline earth metal cation, most preferably magnesium, sodium or ammonium. The ethoxylated alkyl ether sulfate is generally present in the composition at a concentration of about 0 to about 20 wt. %, more preferably about 0.5 wt. % to 15 wt. %.

The ethoxylated alkyl ether sulfate may be made by sulfating the condensation product of ethylene oxide and C₈₋₁₀ alkanol, and neutralizing the resultant product. The ethoxylated alkyl ether sulfates differ from one another in the number of carbon atoms in the alcohols and in the number of moles of ethylene oxide reacted with one mole of such alcohol. Preferred ethoxylated alkyl ether polyethenoxy sulfates contain 12 to 15 carbon atoms in the alcohols and in the alkyl groups thereof, e.g., sodium myristyl (3 EO) sulfate.

Ethoxylated C₈₋₁₈ alkylphenyl ether sulfates containing from 2 to 6 moles of ethylene oxide in the molecule are also suitable for use in the invention compositions. These detergents can be prepared by reacting an alkyl phenol with 2 to 6 moles of ethylene oxide and sulfating and neutralizing the resultant ethoxylated alkylphenol. The concentration of the ethoxylated alkyl ether sulfate surfactant is about 1 to about 8 wt.

The alkali metal or salt of the C₈-C₁₈ linear alkyl benzene sulfonate surfactant is generally used in the instant compositions at a concentration of about 1 to 5 wt. %, more preferably about 2 wt. % to about 4 wt. %. The alkaline urea metal salt of the C₈-C₁₈ linear alkyl benzene sulfonate surfactant is used at a concentration of 6 wt. % to 15 wt. %, more preferably 8 wt. % to 13 wt. %. Examples of suitable sulfonated anionic surfactants are the well known higher alkyl mononuclear aromatic sulfonates such as the higher alkyl benzene sulfonates containing from 8 to 18 carbon atoms, more preferably 10 to 16 carbon atoms in the higher alkyl group in a straight or branched chain, C₈-C₁₅ alkyl toluene sulfonates and C₈-C₁₅ alkyl phenol sulfonates.

One of preferred sulfonates is linear alkyl benzene sulfonate having a high content of 3- (or higher) phenyl isomers and a correspondingly low content (well below 50%) of 2- (or lower) phenyl isomers, that is, wherein the benzene ring is preferably attached in large part at the 3 or higher (for example, 4, 5, 6 or 7) position of the alkyl group and the content of the isomers in which the benzene ring is attached in the 2 or 1 position is correspondingly low. Particularly preferred materials are set forth in U.S. Pat. No. 3,320,174.

The nonionic detergent class includes the condensation products of a higher alcohol (e.g., an alkanol containing 5 to 20 carbon atoms in a straight or branched chain configuration) condensed with 1 to 7. A preferred nonionic surfactant is Shell's Neodol 1-3 which is 13 carbons and 3 moles of ethylene oxide.

Amine oxide semi-polar nonionic surfactants comprise compounds and mixtures of compounds having the formula: 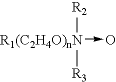
wherein R₁ is an alkyl, 2-hydroxyalkyl, 3-hydroxyalkyl, or 3-alkoxy-2-hydroxypropyl radical in which the alkyl and alkoxy, respectively, contain from 8 to 18 carbon atoms, R₂ and R₃ are each methyl, ethyl, propyl, isopropyl, 2-hydroxyethyl, 2-hydroxypropyl, or 3-hydroxypropyl, and n is from 0 to 10. Particularly preferred are amine oxides of the formula: 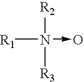
wherein R₁ is a C₁₂₋₁₆ alkyl and R₂ and R₃ are methyl or ethyl. The above ethylene oxide condensates, amides, and amine oxides are more fully described in U.S. Pat. No. 4,316,824 which is hereby incorporated herein by reference.

The instant compositions contain alkyl polysaccharide surfactant. The alkyl polysaccharides surfactants, which are used in conjunction with the aforementioned surfactant have a hydrophobic group containing from about 8 to about 20 carbon atoms, preferably from about 10 to about 16 carbon atoms, most preferably from about 12 to about 14 carbon atoms, and polysaccharide hydrophilic group containing from about 1.5 to about 10, preferably from about 1.5 to about 4, most preferably from about 1.6 to about 2.7 saccharide units (e.g., galactoside, glucoside, fructoside, glucosyl, fructosyl; and/or galactosyl units). Mixtures of saccharide moieties may be used in the alkyl polysaccharide surfactants. The number x indicates the number of saccharide units in a particular alkyl polysaccharide surfactant. For a particular alkyl polysaccharide molecule x can only assume integral values. In any physical sample of alkyl polysaccharide surfactants there will be in general molecules having different x values. The physical sample can be characterized by the average value of x and this average value can assume non-integral values. In this specification the values of x are to be understood to be average values. The hydrophobic group (R) can be attached at the 2-, 3-, or 4-positions rather than at the 1-position, (thus giving e.g. a glucosyl or galactosyl as opposed to a glucoside or galactoside). However, attachment through the 1-position, i.e., glucosides, galactoside, fructosides, etc., is preferred. In the preferred product the additional saccharide units are predominately attached to the previous saccharide unit's 2-position. Attachment through the 3-, 4-, and 6-positions can also occur. Optionally and less desirably there can be a polyalkoxide chain joining the hydrophobic moiety (R) and the polysaccharide chain. The preferred alkoxide moiety is ethoxide.

Typical hydrophobic groups include alkyl groups, either saturated or unsaturated, branched or unbranched containing from about 8 to about 20, preferably from about 10 to about 18 carbon atoms. Preferably, the alkyl group is a straight chain saturated alkyl group. The alkyl group can contain up to 3 hydroxy groups and/or the polyalkoxide chain can contain up to about 30, preferably less than about 10, alkoxide moieties.

Suitable alkyl polysaccharides are decyl, dodecyl, tetradecyl, pentadecyl, hexadecyl, and octadecyl, di-, tri-, tetra-, penta-, and hexaglucosides, galactosides, lactosides, fructosides, fructosyls, lactosyls, glucosyls and/or galactosyls and mixtures thereof.

The alkyl monosaccharides are relatively less soluble in water than the higher alkyl polysaccharides. When used in admixture with alkyl polysaccharides, the alkyl monosaccharides are solubilized to some extent. The use of alkyl monosaccharides in admixture with alkyl polysaccharides is a preferred mode of carrying out the invention. Suitable mixtures include coconut alkyl, di-, tri-, tetra-, and pentaglucosides and tallow alkyl tetra-, penta-, and hexaglucosides.

The preferred alkyl polysaccharides are alkyl polyglucosides having the formula
R₂O(CₙH₂ₙO)r(Z)ₓ
wherein Z is derived from glucose, R is a hydrophobic group selected from the group consisting of alkyl, alkylphenyl, hydroxyalkylphenyl, and mixtures thereof in which said alkyl groups contain from about 10 to about 18, preferably from about 12 to about 14 carbon atoms; n is 2 or 3 preferably 2, r is from 0 to 10, preferable 0; and x is from 1.5 to 8, preferably from 1.5 to 4, most preferably from 1.6 to 2.7. To prepare these compounds a long chain alcohol (R₂OH) can be reacted with glucose, in the presence of an acid catalyst to form the desired glucoside. Alternatively the alkyl polyglucosides can be prepared by a two step procedure in which a short chain alcohol (R₁ OH) can be reacted with glucose, in the presence of an acid catalyst to form the desired glucoside. Alternatively the alkyl polyglucosides can be prepared by a two step procedure in which a short chain alcohol (C₁₋₆) is reacted with glucose or a polyglucoside (x=2 to 4) to yield a short chain alkyl glucoside (x=1 to 4) which can in turn be reacted with a longer chain alcohol (R₂OH) to displace the short chain alcohol and obtain the desired alkyl polyglucoside. If this two step procedure is used, the short chain alkylglucoside content of the final alkyl polyglucoside material should be less than 50%, preferably less than 10%, more preferably less than about 5%, most preferably 0% of the alkyl polyglucoside.

The amount of unreacted alcohol (the free fatty alcohol content) in the desired alkyl polysaccharide surfactant is preferably less than about 2%, more preferably less than about 0.5% by weight of the total of the alkyl polysaccharide. For some uses it is desirable to have the alkyl monosaccharide content less than about 10%.

The used herein, “alkyl polysaccharide surfactant” is intended to represent both the preferred glucose and galactose derived surfactants and the less preferred alkyl polysaccharide surfactants. Throughout this specification, “alkyl polyglucoside” is used to include alkyl polyglycosides because the stereochemistry of the saccharide moiety is changed during the preparation reaction.

An especially preferred APG glycoside surfactant is APG 625 glycoside manufactured by the Cognis Corporation of Ambler, Pa. APG25 is a nonionic alkyl polyglycoside characterized by the formula:
CₙH₂ₙ+1O(C₆H₁₀O₅)ₓH
wherein n=10 (2%); n=122 (65%); n=14 (21-28%); n=16 (4-8%) and n=18 (0.5%) and x (degree of polymerization)=1.6. APG 625 has: a pH of 6 to 10 (10% of APG 625 in distilled water); a specific gravity at 25° C. of 1.1 g/ml; a density at 25° C. of 9.1 lbs/gallon; a calculated HLB of 12.1 and a Brookfield viscosity at 35° C., 21 spindle, 5-10 RPM of 3,000 to 7,000 cps.

The water is present at a concentration of 40 wt. % to 83 wt. %.

In addition to the previously constituents of the light duty liquid detergent, one may also employ normal and conventional adjuvants, provided they do not adversely affect the properties of the detergent. Thus, there may be used various coloring agents and perfumes; ultraviolet light absorbers such as the Uvinuls, which are products of GAF Corporation; sequestering agents such as ethylene diamine tetraacetates; magnesium sulfate heptahydrate; pH modifiers; etc. The proportion of such adjuvant materials, in total will normally not exceed 15% by weight of the detergent composition, and the percentages of most of such individual components will be a maximum of 5% by weight and preferably less than 2% by weight. Sodium bisulfite can be used as a color stabilizer at a concentration of 0.01 to 0.2 wt. %.

The present light duty liquid detergents such as dishwashing liquids are readily made by simple mixing methods from readily available components which, on storage, do not adversely affect the entire composition. Solubilizing agent such as a C₁-C₃ alkyl substituted benzene sulfonate such as sodium cumene or sodium xylene sulfonate and mixtures thereof are used at a concentration of 0.5 wt. % to 10 wt. % to assist in solubilizing the surfactants. The nonrigid gelled compositions of the instant invention are pourable and have an apparent yield value of at least 5 Pa. Beads can be suspended in the nonrigid gel having an apparent yield of at least 5 Pa. The pH of the composition is substantially neutral to skin, e.g., 4.5 to 8 and preferably 5.0 to 7.0. The pH of the composition can be adjusted by the addition of Na₂O (caustic soda) to the composition.

The following examples illustrate liquid cleaning compositions of the described invention. Unless otherwise specified, all percentages are by weight. The exemplified compositions are illustrative only and do no limit the scope of the invention. Unless otherwise specified, the proportions in the examples and elsewhere in the specification are by weight.

### DESCRIPTION OF THE PREFERRED EMBODIMENTS

### EXAMPLE 1

The following formulas were prepared at room temperature by simple liquid mixing procedures as previously described

| | 1 | 2 | 3 | 4 | 5 | 6 | 7 | 8 | 9 | 10 | 11 | 12 | 13 |
|---|---|---|---|---|---|---|---|---|---|---|---|---|---|
| Mg Linear alkyl Benzene sulfonate | 9.02 | 6.31 | 6.31 | 6.31 | 6.31 | 6.31 | 6.31 | 6.31 | 5.05 | 5.05 | 5.37 | 4.744 | 6.00 |
| Na Linear alkyl Benzene sulfonate | 3.00 | 2.10 | 2.10 | 2.10 | 2.10 | 2.10 | 2.10 | 2.10 | 1.68 | 1.68 | 1.79 | 1.55 | 2.00 |
| Lauryl myristal amine oxide | 5.00 | 3.50 | 3.50 | 3.50 | 3.50 | 3.50 | 3.50 | 3.50 | 2.80 | 2.80 | 2.98 | 2.63 | 3.33 |
| SD No. 3 alcohol | 2.15 | 1.51 | 1.51 | 1.51 | 1.51 | 1.51 | 1.51 | 1.51 | 1.20 | 1.20 | 1.28 | 1.13 | 1.43 |
| NH4AEOS 1:3 OXO | 11.50 | 8.05 | 8.05 | 8.05 | 8.05 | 8.05 | 8.05 | 8.05 | 6.44 | 6.44 | 6.84 | 6.04 | 7.65 |
| APG625 | 9.50 | 6.65 | 6.65 | 6.65 | 6.65 | 6.65 | 6.65 | 6.65 | 5.32 | 5.32 | 5.65 | 4.99 | 6.32 |
| Dimethylol dimethyl hydantoin | 0.11 | 0.08 | 0.08 | 0.08 | 0.08 | 0.08 | 0.08 | 0.08 | 0.06 | 0.06 | 0.07 | 0.06 | 0.07 |
| 40% SXS solution | 1.25 | 0.88 | 0.88 | 0.88 | 0.88 | 0.88 | 0.88 | 0.88 | 0.70 | 0.70 | 0.74 | 0.06 | 0.07 |
| Dissolve D-40 | 0.13 | 0.09 | 0.09 | 0.09 | 0.09 | 0.09 | 0.09 | 0.09 | 0.07 | 0.07 | 0.08 | 0.07 | 0.09 |
| Neodol 1-3 | 0.00 | 15.00 | 30.00 | 13.75 | 12.50 | 10.00 | 7.50 | 5.00 | 10.00 | 15.00 | 15.00 | 15.00 | 5.00 |
| Water | 58.26 | 55.78 | 40.78 | 57.03 | 58.28 | 60.78 | 63.28 | 65.78 | 66.63 | 61.63 | 60.16 | 63.09 | 67.24 |
| Separation (0 = none; 4 = severe) | 0 | 0 | 0 | 1 | 2 | 3 | 4 | 4 | 3 | 0 | 0 | 0 | 4 |
| Suspends gelatin beads | no | yes | yes | no | no | no | no | no | no | yes | yes | yes | no |
| Pourable | yes | yes | no | yes | yes | yes | yes | yes | yes | yes | yes | yes | yes |

1. A gelled light duty liquid cleaning composition comprising approximately by weight:
(a) 2% to 9% of a magnesium salt of a C₈-C₁₈ linear alkyl benzene sulfonate surfactant;
(b) 0% to 4% of a sodium salt of a C₈-C₁₈ linear alkyl benzene sulfonate surfactant;
(c) 0% to 6% of an amine oxide surfactant;
(d) 3% to 8% of an alkyl polyglucoside;
(e) 10 to 20% of an ethoxylated C₈-C₁₈ alkyl ether sulfate surfactant;
(f) 0.25% to 3% of a C₁-C₃ alkanol;
(g) 10% to 20% of a hydrophobic ethoxylated nonionic surfactant having an HLB of from about 2 to about 10; and
(h) the balance being water.

2. A gelled cleaning composition according to claim 1 which includes, in addition, 0.3% to 2% by weight of a solubilizing agent which is a water soluble salts of C₁-C₃ alkyl substituted benzene sulfonate hydrotropes and mixtures thereof.

3. A gelled cleaning composition according to claim 1 further including a color stabilizer.

4. A gelled cleaning composition according to claim 1 further including a chelating agent.

5. A gelled cleaning composition according to claim 1 further including a preservative.

6. A gelled cleaning composition according to claim 1 further including a perfume.

7. A gelled composition according to claim 1 further including beads suspended in said gelled composition.
